(19) United States
(12) Patent Application Publication
(10) Pub. No.: US 2006/0099313 A1
(43) Pub. Date: May 11, 2006

(54) System for reprocessing pre-cooked flour based food products

(76) Inventor: Dan H. Sher, St. Louis Park, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/224,697

(22) Filed: Sep. 12, 2005

Related U.S. Application Data
(60) Provisional application No. 60/608,813, filed on Sep. 10, 2004.

(51) Int. Cl. A47J 39/00

(52) U.S. Cl. 426/520

(57) ABSTRACT

Methods and system for enabling the retail sale of hot, fresh miniature donuts, and other pre-cooked foods, where using a donut fryer is not an option. By quickly reheating frozen dough-based food products at a point of sale, donut stands can now be set up in locations that are not conducive to frying or heavy fumes. Locations such as small concession areas, food transport vehicles or areas in which a donut fry smell and/or high temperature grease may not be appropriate are the target of this invention.

### PRIORITY CLAIM

The present application claims priority to U.S. Provisional Application No. 60/608,813 filed Sep. 10, 2004, and entitled “SYSTEM FOR REPROCESSING PRE-COOKED FLOUR BASED FOOD PRODUCTS,” which is hereby incorporated by reference in its entirety.

### BACKGROUND OF THE INVENTION

Miniature or “mini” donuts are typically made using a small automated fryer that forms the donuts, places them in a fry tank and uses a conveying system to deposit them in a pan. The donuts are usually hot, crisp and fresh when sold to the consumer. While this approach is appealing to many, it has drawbacks.

The automated fryers use grease heated to temperatures of about 375° F., which can be a potential safety threat to workers and customers in various situations. The cooking process also creates fumes from the cooking of the donuts. In some situations, exhaust fans can be used to reduce the amount of fumes in the area, but this adds expense to providing the donuts. Outdoor cooking may allow fumes to permeate the area, which can sometimes be a powerful marketing tool. However, such strong odors may not be acceptable in some situations.

### SUMMARY OF THE INVENTION

The process and system described herein enables the retail sale of hot, fresh miniature donuts, and other pre-cooked foods, where using a donut fryer is not an option. With this invention, donut stands can now be set up in locations that are not conducive to frying or heavy fumes. Locations such as small concession areas, mobile food transport vehicles or areas in which a donut fry smell and/or high temperature grease may not be appropriate are the target of this invention (e.g., theaters, gaming and arcade centers, roller rinks, etc.).

In one aspect, the present disclosure comprises methods for preparing miniature donuts and other food products in concession locations that are not conducive to the use of deep fryers or the generation of smoke and fumes. The methods can comprise one or more of the following steps including preparation of miniature donuts at a centralized bakery or suitable preparation area; freezing the miniature donuts upon completion of the cooking product; packaging of the frozen miniature donuts in either a bulk or serving size amount; transporting the frozen miniature donuts to a remote concession location such as, for example, a movie theater, sporting location; cafeteria, community gathering or the like and reheating of the frozen miniature donuts for consumption at the remote concession location.

In another aspect, the present disclosure comprises a system for simulating the taste and texture of a freshly fried mini donut at a vending location remote from a donut preparation location. The donut preparation location can comprise the necessary cooking, freezing and packaging equipment necessary for processing bulk quantities of miniature donuts. The vending location can comprise a point-of-sale and a reheating oven for quickly restoring the bulk prepared miniature donuts to the taste, texture and temperature of the freshly prepared miniature donuts at the donut preparation location without generating smoke, fumes and/or odor as is typically encountered when deep frying miniature donuts.

The various embodiments and aspects of the present disclosure are not intended to be exhaustive or to limit the invention to the precise forms disclosed in the following detailed description. Rather, the embodiments are chosen and described so that others skilled in the art may appreciate and understand the principles and practices of the invention.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 is a flowchart illustrating a method for providing freshly cooked food products at a vending location remotely located from a preparation location.

FIG. 2 is a perspective view of a reheating oven used for simulating freshly cooked miniature donuts at a vending location remotely located from a preparation location.

FIG. 3 is a pictorial view of a system for providing freshly cooked food products at a vending location utilizing a preparation location and a remotely located concession location.

### DETAILED DESCRIPTION OF THE PREFERRED EMBODIMENTS

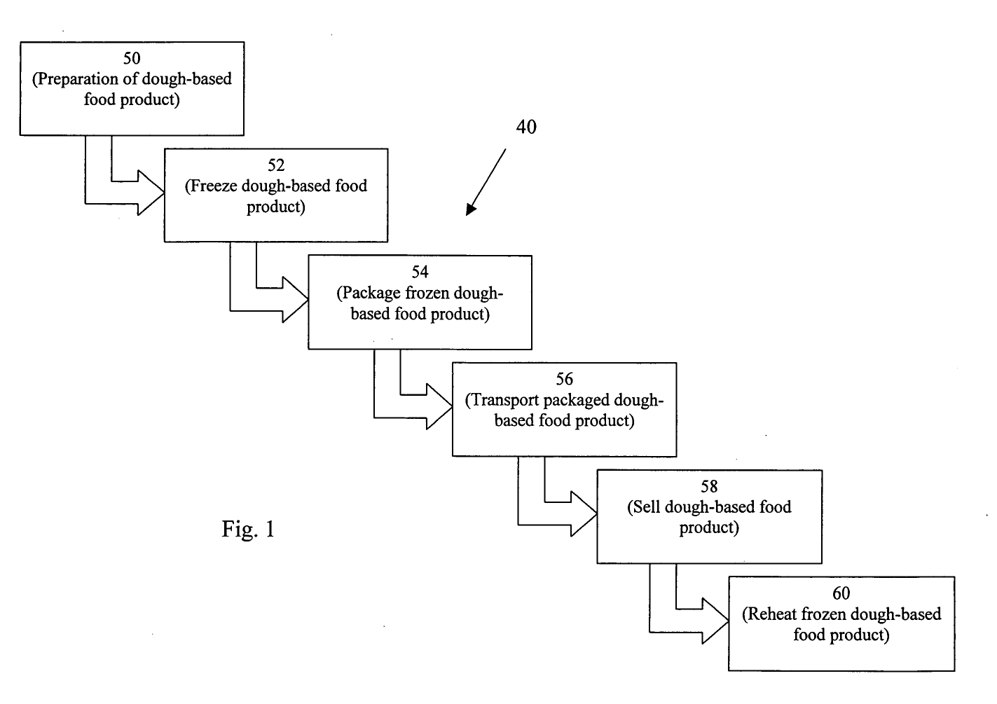

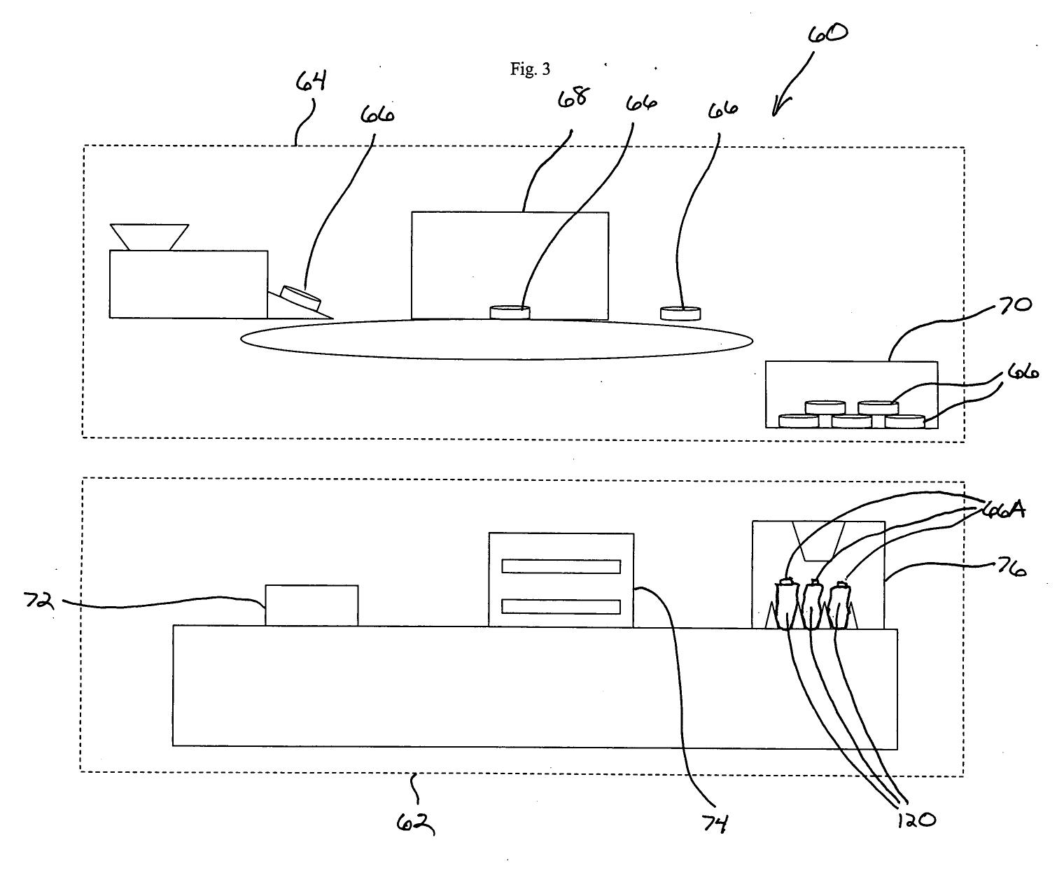

As illustrated in FIGS. 1 and 3, a process 40 and a system 60 can be utilized for providing a fresh, reheated cooked dough product at a concession or vending location 62 located remotely from an initial preparation location 64. Process 40 can comprise a preparation step 50 in which a raw dough or batter-based product can be cooked and/or heated to form a cooked dough product. In a preferred embodiment, preparation step 50 can be used for bulk preparation of a plurality of deep fried mini donuts 66.

Once prepared, the cooked dough product can be immediately frozen in a freezing step 52. Freezing step 52 can comprise either a batch or continuous freezer 68 such as, for example, chest or walk-in style freezers or a continuous tunnel freezer. After freezing step 52, the cooked dough product can be packaged in a packaging step 54. Within packaging step 54, the frozen cooked dough products can be placed in plastic bag style packaging and/or within a paperboard or cardboard box 70 or similar packaging. In some instances, packaging step 54 can comprise bulk packaging the frozen cooked dough products in a single bulk package or packaging step 54 can comprise packaging smaller serving sizes such as, for example, serving sizes of 5-15 mini donuts per package.

Following packaging step 54, the packaged, frozen cooked dough products can be transported to the vending location 62 utilizing a transportation step 56. Within transportation step 56, the packaged, frozen cooked dough products can be transported from the initial preparation location 64 utilized in preparation step 50 to a consumption site where the cooked dough products are sold a point of sale 72 in a selling step 58. Point of sale can comprise a concession counter, concession cart, a concession booth, a serving line or the like and can further include a cash register or drawer for collecting money and dispensing change. Within selling step 58, the cooked dough products are preferably sold in a serving quantity that can comprise from about 5 to about 20 of the cooked dough products.

At the consumption site, the frozen cooked dough products are prepared for consumption in a reheating step 60 that utilizes a reheating oven 74. Depending upon consumption rate, preparation of freshly reheated cooked dough products can be accomplished immediately following selling step 58 or reheating step 60 can performed essentially continuously such that reheating step 60 precedes selling step 58 such that freshly reheated cooked dough products can be immediately delivered to a purchaser. In some instances, freshly reheated cooked dough products can be placed under a warming device 76 such as, for example, a radiant or infrared heater, to maintain the temperature of the freshly reheated cooked dough products until they are sold in selling step 58.

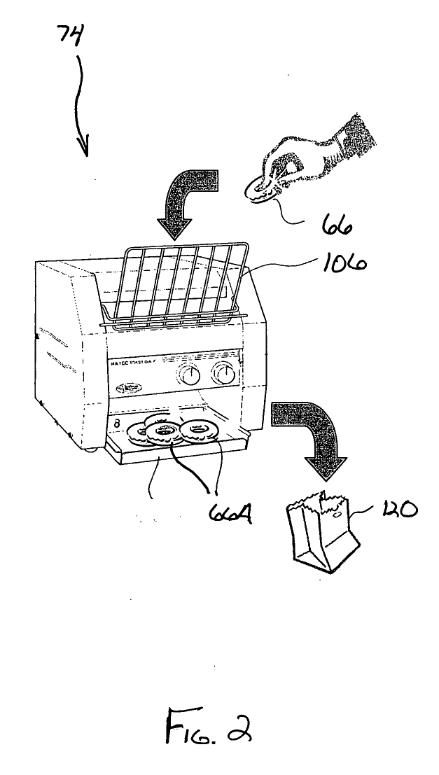

FIG. 2 more clearly illustrates reheating step 60 for reheating frozen or room temperature cooked dough products such as, for example, miniature donuts 66. Reheating oven 74 may be sourced from several different models by different suppliers and is preferably, preconfigured by the donut (or other pre-cooked food) supplier to obtain the desired temperature, texture and consistency of the finished donuts. In one representative example, oven 74 can comprise any suitable oven for achieving the desired cooking characteristics such as, for example, a toaster oven and/or convection oven. One suitable oven 74 can comprise the model QCS 350 conveyor toaster oven manufactured by Star Manufacturing International of St. Louis, Mo.

Depending upon volume and the requirements of the consumption site, oven 74 can comprise a batch oven design or alternatively, a continuous oven design. A retail agent such as, for example, the person selling the cooked dough precuts in selling step 58 places mini donuts 66 in top load rack 106 such that the mini donuts 66 can be transported past one or more heating elements within oven 74 on a conveyor. Reheated donuts 66A are dropped onto a discharge rack 108 where the retail agent takes them and places them in a bag 120 for sale to the customer. In one example embodiment, the bags are glassine bags.

The following inventive method has been developed to enable the sale of donuts where the use of donut fryers may not be appropriate. Small donuts, for instance, are cooked in a donut fryer off-site. These donuts are the same as will be re-created on the retail site. The donuts are then transported to the retail site for use, or they may also be frozen to preserve freshness before transportation. The donuts may be held at the retail site on baking pans ready for the “refreshening” process.

Referring to FIG. 1, once a package of donuts is sold, the retail agent places the appropriate number of mini donuts 66 in the load rack 106 of vendor supplied conveyor toaster 74. Generally, the appropriate number of mini donuts 66 can comprise a serving amount from about 5 mini donuts to about 20 mini donuts. The reheating oven 74 can operate at a predetermined temperature and a predetermined conveyor rate such that mini donuts 66 are exposed to the optimum toasting time to reheat the donuts to the proper serving temperature. In some embodiments, reheating oven can be preconfigured for operation between about 300° F. to about 450° F. with reheat times for a single serving of small donuts (about one dozen) of about 45 seconds for room temperature donuts, and about 85 seconds for pre-cooked frozen donuts. Reheated donuts 66A are ejected by the toaster conveyor on discharge rack 108 where the retail agent places the donuts in specially supplied glassine bags 120 for sale to the customer.

It will thus be seen according to the invention a highly advantageous method a system for preparing miniature donuts at remote concession locations that are comparable to donuts fried on-site. While the invention has been described in connection with what is presently considered to be the most practical and preferred embodiments, it will be apparent to those of ordinary skill in the art that the invention is not to be limited to the disclosed embodiments. It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products.

What is claimed:

1. A method for simulating freshly cooked flour-based food products comprising:
preparing a cooked flour-based food product at a cooking location;
freezing the cooked flour-based food product at the cooking location;
packaging a frozen cooked flour-based food product;
transporting the frozen cooked flour-based food product for shipment to a remote concession location;
selling an amount of the cooked flour-based food product at the remote concession location; and
reheating the frozen cooked flour-based food product at the remote concession location to satisfy a sale of the cooked flour-based food product.

2. The method of claim 1, wherein the cooked flour-based food product comprises a mini-donut.

3. The method of claim 1, wherein the cooking location is a bakery.

4. The method of claim 1, wherein the remote concession location is selected from the group comprising: a cafeteria, a sporting event and a theater.

5. The method of claim 1, wherein reheating the frozen cooked flour-based product comprises heating the frozen cooked flour-based product in a continuous oven for a time period less than about two minutes.

6. The method of claim 5, wherein the frozen cooked flour-based product is heated for a time period less than about one minute.

7. The method of claim 1, wherein preparing the cooked flour-based food product at the cooking location comprises deep-frying a flour-based food product with a continuous deep-fryer or a batch deep-fryer.

8. The method of claim 1, wherein freezing the cooked flour-based food product at the cooking location comprises freezing the cooked flour-based food product with a continuous freezer or a batch freezer.

9. The method of claim 1, wherein the step of selling the amount of the cooked flour-based food product at the remote concession location precedes the step of reheating the frozen cooked flour-based food product at the remote concession location.

10. A system for simulating a taste and texture of freshly cooked miniature donuts at a remote concession location comprising:
a bulk preparation location having facilities for bulk production of deep fried miniature donuts wherein the bulk preparation location includes a deep fryer, a freezer and bulk packaging equipment; and
a vending location remotely located from the bulk preparation location; the vending location having a point-of-sale and a reheating oven wherein said reheating oven is capable of reheating a serving portion of bulk prepared deep fried miniature donuts to the taste, texture and temperature of the deep fried miniature donuts in a time period less than about 2 minutes.

11. The system of claim 10, wherein the reheating oven is capable of reheating a serving portion of frozen deep fried miniature donuts to the taste and texture of the deep fried miniature donuts in a time period less than about 1 minute.

12. The system of claim 10, wherein the reheating oven comprises an oven selected from the group comprising: a convection oven, a toaster oven, a continuous oven and combinations thereof.

13. The system of claim 10, wherein a serving portion comprises from about 5 to about 20 bulk prepared deep fried miniature donuts.

14. The system of claim 10, wherein the bulk prepared deep fried miniature donuts are in a transitional state selected from the group comprising: a frozen miniature donut; a refrigerated miniature donut and a room-temperature miniature donut.

15. The system of claim 10, wherein the vending location further comprises a warming station for maintaining the temperature of the reheated miniature donuts until the reheated miniature donuts are sold at the point-of-sale.
